(19) United States
(12) Patent Application Publication
(10) Pub. No.: US 2007/0006042 A1
(43) Pub. Date: Jan. 4, 2007

(54) Software debug support for cache flush with access to external data location(s) through debug port

(75) Inventors: Bruce L. Beukema, Hayfield, MN (US); Alexander Mesh, Haifa (IL); Nabil A. Rizk, Apex, NC (US); Robert A. Shearer, Rochester, MN (US); Charles D. Wait, Byron, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/171,781

(22) Filed: Jun. 30, 2005

(51) Int. Cl. G06F 11/00

(52) U.S. Cl. 714/38

(57) ABSTRACT

A processor receives one or more debug commands through a debug port to help debug software being executed by the processor. In response to a first one or more of the debug commands, the processor stops execution of the software, and flushes data from cache memory of the processor to one or more data locations external to the processor. In response to a second one or more of the debug commands, the processor accesses one or more data locations external to the processor, and resumes execution of the software.

### BACKGROUND OF THE INVENTION

1. Field of the Invention

The invention generally relates to computer processors and, more particularly, to debugging software programs executing thereon.

2. Description of the Related Art

Debugging software programs being executed on a processor entails observing the state of processor element(s), system memory, and/or device(s) under test to analyze conditions leading to error in the software execution. Debugging generally refers to the process of identifying (and hopefully fixing) errors or “bugs” in a program.

To facilitate debugging, programmers typically demand the ability to see the state of each processor element, system memory, as well as other devices which are under test so as to analyze the conditions that caused an error. As part of the program error debug, it is essential to be able to observe the contents of the processor cache, as it contains the most recent version of data that is associated with system memory.

Due to complex interaction of the processor and system components, it is a challenge to provide this ability, including observing the contents of the processor cache, without altering processor behavior. Changing processor behavior might have the undesirable effect of changing or even eliminating the error which is being diagnosed.

Accordingly, what is needed is a mechanism for observing and/or modifying system memory, including cached portions, that is non-disruptive to processor operation.

### SUMMARY

One or more disclosed methods for debugging software being executed by a processor comprise receiving by the processor one or more debug commands through a debug port; and in response to the one or more debug commands, stopping execution of the software, flushing data from cache memory of the processor to one or more data locations external to the processor, accessing one or more data locations external to the processor, and resuming execution of the software.

One or more disclosed processors comprise one or more processing units to execute software; cache memory to store data for the software; a debug port to receive one or more debug commands; and logic to, in response to the one or more debug commands, stop execution of the software, flush data from the cache memory to one or more data locations external to the processor, access one or more data locations external to the processor, and resume execution of the software.

One or more disclosed systems comprise a host to issue one or more debug commands; a memory controller; system memory coupled to the memory controller; and a processor comprising one or more processing units to execute software, cache memory to store data for the software, a debug port coupled to receive one or more debug commands from the host, and logic to, in response to the one or more debug commands, stop execution of the software, flush data from the cache memory to the system memory, access the system memory, and resume execution of the software.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates, for one or more embodiments, a system having a processor that supports a cache flush with access to one or more external data locations through a debug port;

FIG. 2 illustrates, for one or more embodiments, a flow diagram to help perform software debugging using a cache flush with access to one or more external data locations through a debug port;

FIG. 3 illustrates, for one or more embodiments, a flow diagram to stop processing of external commands for the flow diagram of FIG. 2;

FIG. 4 illustrates, for one or more embodiments, a flow diagram to flush data from cache memory and access one or more external data locations for the flow diagram of FIG. 2; and

FIG. 5 illustrates, for one or more embodiments, a flow diagram to allow processing of other external commands for the flow diagram of FIG. 2.

### DETAILED DESCRIPTION

Embodiments of the invention generally provide software debugging support in a processor for a cache flush with access to one or more external data locations, such as a location in system memory for example, through a debug port. Supporting a cache flush to one or more external data location(s) helps allow observation of cache content through a subsequent access of such external data location(s) through the debug port.

Cache content for one or more embodiments may then be observed in a manner transparent to the software being debugged with no or minimal effect on the software's behavior. For one or more embodiments where, for example, a processor helps maintain cache coherence using system software, observation of cache content may be important because the cache may contain the most recent version of data associated with one or more external data locations.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### An Exemplary System

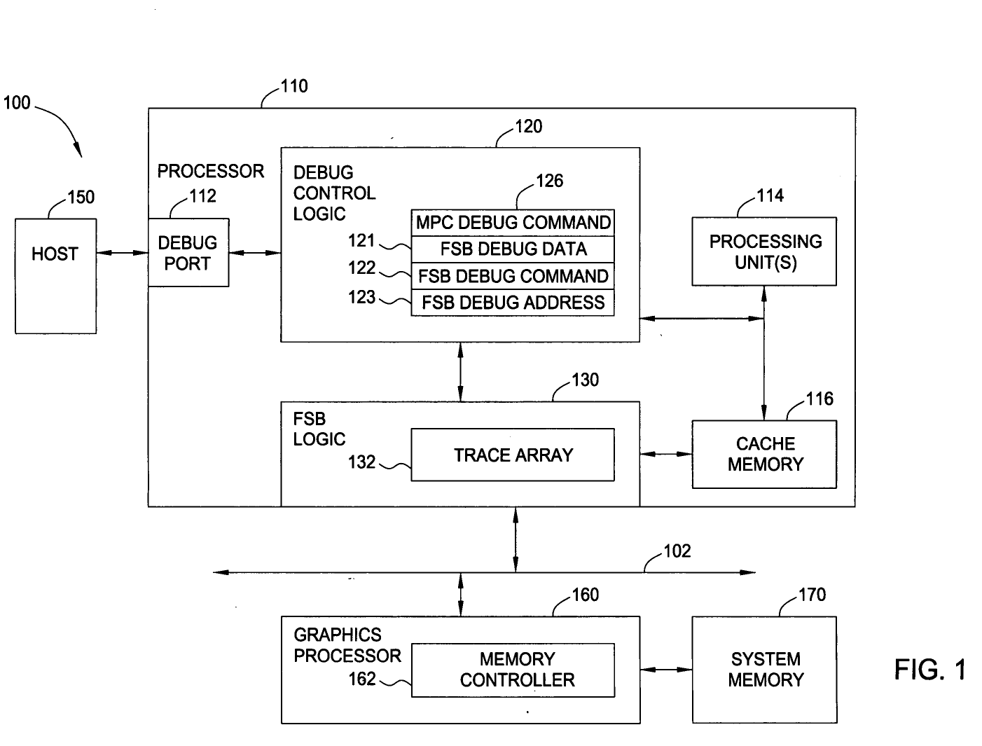

FIG. 1 illustrates, for one or more embodiments, a system 100 comprising a processor 110, a host 150, a graphics processor 160, and system memory 170 external to processor 110. Graphics processor 160 comprises a memory controller 162 coupled to control access to system memory 170 for graphics processor 160. Graphics processor 160 may be coupled to processor 110 over a front side bus (FSB) 102, for example, and support access to system memory 170 for processor 110.

Host 150 may be coupled to processor 110 through a debug port 112 of processor 110 to help debug software being executed by processor 110. Debug port 112 for one or more embodiments may be, for example, a Joint Team Access Group (JTAG) port. Host 150 for one or more embodiments may execute any suitable software to help control and/or observe the execution of software by processor 110. Host 150 for one or more embodiments may observe, for example, the state of any suitable element(s) of processor 110, system memory 170, and/or any suitable device(s) under test to allow conditions leading to error in software execution to be analyzed.

Processor 110 for one or more embodiments, as illustrated in FIG. 1, may comprise one or more processing units 114 to execute software and cache memory 116 to store instructions and data loaded from system memory 170 for the software being executed. Cache memory 116 may also store data that has been created or processed in executing the software. The instructions and data in cache memory 116 for one or more embodiments may correspond to one or more addresses which in turn may correspond to one or more locations in system memory 170. Processor 110 for one or more embodiments may execute system software to help maintain coherence between cache memory 116 and system memory 170.

Although described in connection with storing data corresponding to one or more addresses corresponding in turn to one or more locations in system memory 170, cache memory 116 for one or more embodiments may store data corresponding to one or more addresses corresponding to any suitable one or more external data locations. Cache memory 116 may, for example, store data corresponding to one or more memory-mapped registers of one or more devices coupled to processor 110.

Processor 110 for one or more embodiments, as illustrated in FIG. 1, may comprise debug control logic 120 coupled to receive commands through debug port 112 to help support host 150 to control and/or observe the execution of software. Debug control logic 120 for one or more embodiments may support a cache flush to system memory 170 and subsequent access to system memory 170 through debug port 112 to help allow observation of content of cache memory 116 as processing unit(s) 114 execute software. As used herein, the term cache flush generally refers to a transfer of some or all of cache contents to system memory.

For one or more embodiments where, for example, processor 110 helps maintain coherence between cache memory 116 and system memory 170 using system software, observation of content of cache memory 116 may be important because cache memory 116 may contain the most recent version of data associated with system memory 170. Debug control logic 120 for one or more embodiments may also support a cache flush to system memory 170 and subsequent access to system memory 170 through debug port 112 to help modify data to be processed by the software for debug purposes. Modifying data may allow programmers to identify the cause of suspected errors by modifying cached memory locations to contain particular values that are likely to result in the suspected error.

### Exemplary Debug Operations

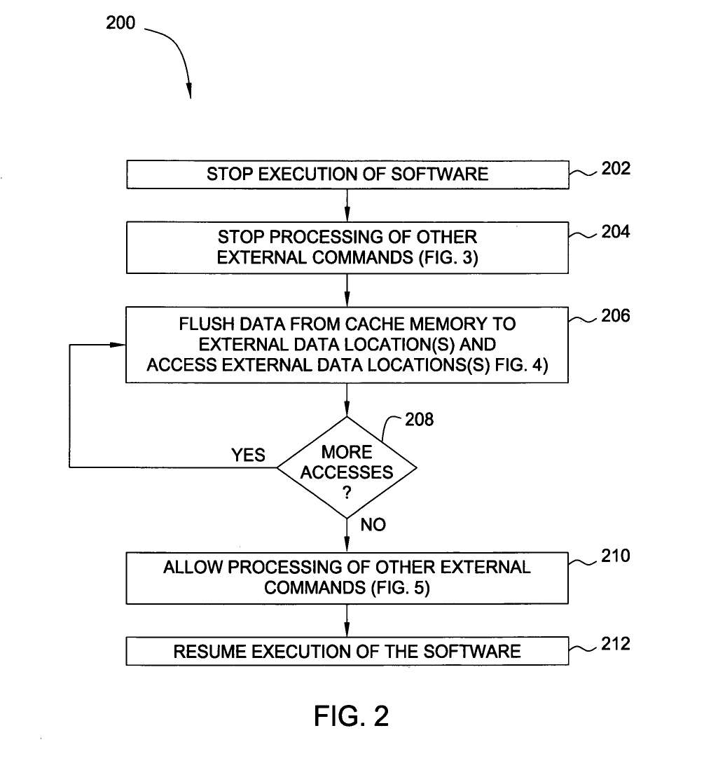

Host 150 and processor 110 for one or more embodiments may help observe or modify content of cache memory 116 as processor 110 executes software in accordance with a flow diagram 200 of FIG. 2.

For block 202 of FIG. 2, host 150 issues one or more commands to processor 110 through debug port 112 to stop the execution of the software by processing unit(s) 114. Debug control logic 120 may comprise any suitable logic coupled to stop execution of the software by processing unit(s) 114 in response to such command(s) in any suitable manner.

For block 204 of FIG. 2, host 150 issues one or more commands to processor 110 through debug port 112 to stop processing of commands by processor 110 from one or more external sources, such as graphics processor 160 for example. Debug control logic 120 may comprise any suitable logic coupled to stop processing of commands by processor 110 from one or more external sources in response to such command(s) in any suitable manner. For example, the debug control logic 120 may include logic configured to initiate one or more commands to external sources via the front side bus or other interface.

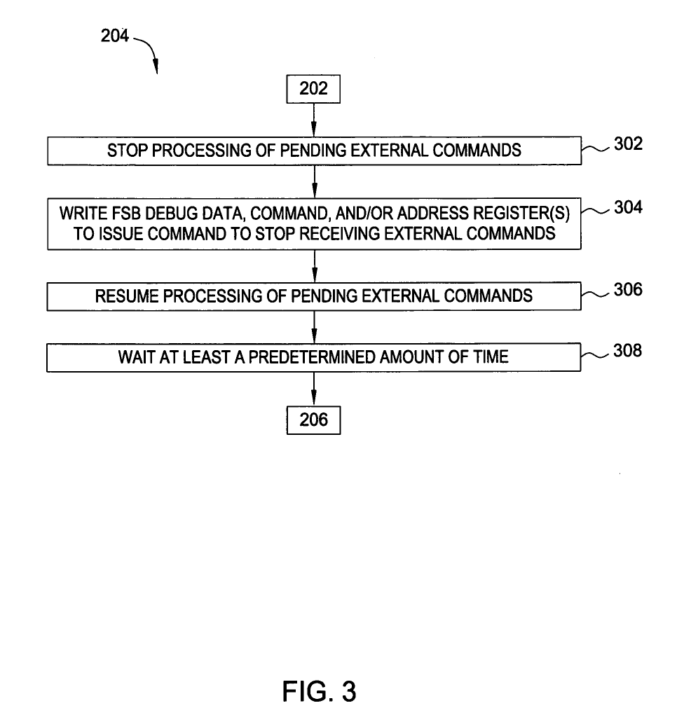

Host 150 and processor 110 for one or more embodiments may perform operations for block 204 in accordance with the flow diagram illustrated in FIG. 3.

For block 302 of FIG. 3, host 150 may issue one or more commands to processor 110 to stop processing of any pending commands from one or more external sources. Host 150 for one embodiment may activate an Ignore All Commands bit in a memory-mapped register of debug control logic 120, and debug control logic 120 may then suspend processing of any pending external commands. The CPU initiated commands may already be suspended and the Ignore All command may temporarily suspend upbound commands. After the CPU responds to any commands that had already made it up, there are no more CPU-initiated or CPU-reactionary commands left to send down. Therefore, the downbound path is temporarily drained, allowing the host to issue a command to the GPU to suspend all upbound traffic. Subsequently, the Ignore All command may be deactivated as the upbound path is drained. Host 150 for one embodiment for block 302 may additionally wait at least a predetermined amount of time to allow any external commands in process to be completed by processor 110.

For block 304, host 150 may write predetermined data to a memory-mapped front side bus (FSB) debug data register 121 of debug control logic 120, may write a predetermined command to a memory-mapped FSB debug command register 122 of debug control logic 120, and/or may write a predetermined address to a memory-mapped FSB debug address register 123 of debug control logic 120. As one example, host 150 may write all 1's in FSB debug data register 121, a write or store command in FSB debug command register 122, and any suitable predetermined address in FSB debug address register 123. Debug control logic 120 may be coupled to FSB logic 130 to then issue one or more commands over FSB 102 to stop issuance of commands to processor 110 by one or more external sources, such as graphics processor 160 for example.

For block 306, host 150 may issue one or more commands to processor 110 to resume processing of any pending commands from one or more external sources. Host 150 for one embodiment may deactivate an Ignore All Commands bit in a memory-mapped register of debug control logic 120, and debug control logic 120 may then resume processing of any pending external commands. Host 150 for one embodiment for block 306 may additionally wait at least a predetermined amount of time to allow any pending external commands to be performed by processor 110.

For block 308, host 150 may wait, if necessary, at least a predetermined amount of time to allow the command(s) issued for block 304 to one or more external sources to be performed.

Host 150 for one or more other embodiments for block 204 of FIG. 2 may issue one or more commands to processor 110 to ignore one or more commands issued to processor 110 from one or more external sources, such as from graphics processor 160 for example.

Host 150 for block 206 issues one or more commands to processor 110 to flush data from cache memory 116 to one or more external data locations, such as one or more locations in system memory 170 for example, and to access such data location(s) to read or modify the flushed data. Debug control logic 120 may comprise any suitable logic coupled to flush data from cache memory 116 to one or more external data locations and to access such data location(s) to read or modify the flushed data in response to such command(s) in any suitable manner.

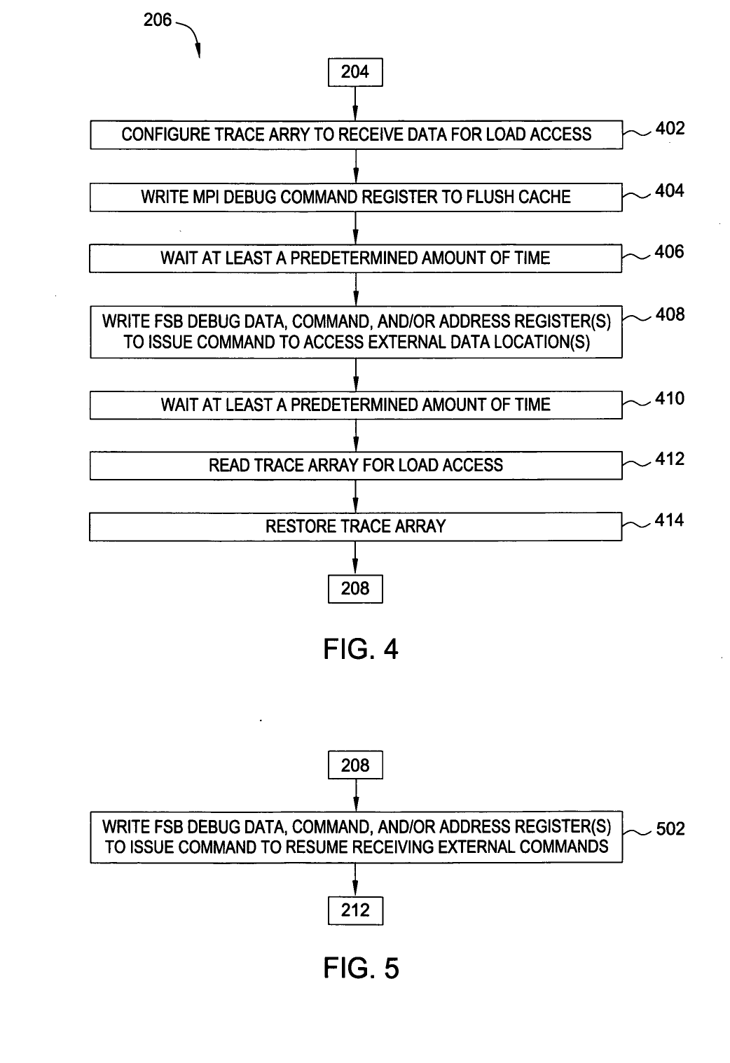

Host 150 and processor 110 for one or more embodiments may perform operations for block 206 in accordance with the flow diagram illustrated in FIG. 4.

For block 402 of FIG. 4, host 150 may issue one or more commands to processor 110 to configure a trace array 132 of FSB logic 130 to receive data from one or more external data locations. If host 150 is to access external data location(s) to modify and not observe data from such data location(s), host 150 may skip operations for block 402.

For block 404, host 150 may write a flush command and a desired address of a cache line in cache memory 116 to a memory-mapped debug command register 126 of debug control logic 120. Debug control logic 120 may be coupled to a processor bus to then issue one or more commands over the processor bus to flush the cache line of data corresponding to the desired address in cache memory 116 to one or more external data locations, such as one or more locations in system memory 170 for example.

For block 406, host 150 may wait at least a predetermined amount of time to allow the cache line at the desired address to be flushed for block 404.

For block 408, host 150 may write an access command to FSB debug command register 122 of debug control logic 120 and may write a desired address of an external data location to be accessed to FSB debug address register 123 of debug control logic 120. The desired external data location address may correspond to the memory address evicted from the cache in block 404. Host 150 may optionally write a transaction identifier to FSB debug command register 122. For a read or load access, host 150 may write a load access command to FSB debug command register 122. For a write or store access, host 150 may write a store access command to FSB debug command register 122 and may write the data to be stored to FSB debug data register 121. Debug control logic 120 may be coupled to FSB logic 130 to then issue a corresponding command to access the external data location at the desired address.

For block 410, host 150 may wait at least a predetermined amount of time for a load access for data to be read from the external data location at the desired address. For a store access, host 150 may optionally skip operations for block 410.

For block 412, host 150 may read from trace array 132 data read for a load access. For a store access, host 150 may skip operations for block 412.

For block 414, host 150 may restore trace array 132 to its state prior to configuring trace array 132 for block 402. For a store access, host 150 may skip operations for block 414.

Returning to FIG. 2, if host 150 for block 208 is to observe or modify more content of cache memory 116, host 150 and processor 110 for one or more embodiments may repeat operations for block 206 to flush data from cache memory 116 to one or more external data locations, such as one or more locations in system memory 170 for example, and to access such data location(s) to read or modify the flushed data.

For block 210 of FIG. 2, host 150 issues one or more commands to processor 110 through debug port 112 to allow processing of commands by processor 110 from one or more external sources. Debug control logic 120 may comprise any suitable logic coupled to allow processing of commands by processor 110 from one or more external sources in response to such command(s) in any suitable manner.

Host 150 and processor 110 for one or more embodiments may perform operations for block 210 in accordance with the flow diagram illustrated in FIG. 5.

For block 502 of FIG. 5, host 150 may write predetermined data to FSB debug data register 121 of debug control logic 120, may write a predetermined command to FSB debug command register 122 of debug control logic 120, and/or may write a predetermined address to FSB debug address register 123 of debug control logic 120. As one example, host 150 may write all 0's in FSB debug data register 121, a write or store command in FSB debug command register 122, and any suitable predetermined address in FSB debug address register 123. Debug control logic 120 may be coupled to FSB logic 130 to then issue one or more commands over FSB 102 to resume issuance of commands to processor 110 by one or more external sources, such as graphics processor 160 for example.

For block 212 of FIG. 2, host 150 issues one or more commands to processor 110 through debug port 112 to resume the execution of the software by processing unit(s) 114. Debug control logic 120 may comprise any suitable logic coupled to resume execution of the software by processing unit(s) 114 in response to such command(s) in any suitable manner.

### CONCLUSION

Embodiments of the invention generally providing software debugging support in a processor for a cache flush with access to one or more external data locations, such as a location in system memory for example, through a debug port have therefore been described.

While the foregoing is directed to embodiments of the present invention, other and further embodiments of the invention may be devised without departing from the basic scope thereof, and the scope thereof is determined by the claims that follow.

What is claimed is:

1. A method for debugging software being executed by a processor comprising:
receiving by the processor debug commands through a debug port;
in response to a first one or more of the debug commands:
stopping execution of the software,
flushing data from cache memory of the processor to one or more data locations external to the processor; and
in response to a second one or more of the debug commands:
accessing one or more data locations external to the processor, and
resuming execution of the software.

2. The method of claim 1, comprising:
in response to the one or more debug commands, issuing one or more commands to stop issuance of commands to the processor by another processor.

3. The method of claim 1, comprising:
in response to the one or more debug commands, ignoring one or more commands issued to the processor by another processor.

4. The method of claim 1, comprising:
executing system software by the processor in a non-debug mode to help maintain coherence between the cache memory and data location(s) external to the processor.

5. The method of claim 1, comprising:
in response to the one or more debug commands, configuring a trace array to receive data accessed from one or more data locations external to the processor.

6. The method of claim 1, wherein the flushing comprises flushing one cache line corresponding to an address to a data location corresponding to the same address and wherein the accessing comprises accessing the data location corresponding to the same address.

7. The method of claim 1, wherein the flushing comprises flushing data to memory external to the processor and wherein the accessing comprises accessing the external memory.

8. A processor comprising:
one or more processing units to execute software;
cache memory to store data for the software;
a debug port to receive one or more debug commands; and
logic to, in response to the one or more debug commands, stop execution of the software, flush data from the cache memory to one or more data locations external to the processor, access one or more data locations external to the processor, and resume execution of the software.

9. The processor of claim 8, wherein the logic is to issue, in response to the one or more debug commands, one or more commands to stop issuance of commands to the processor by another processor.

10. The processor of claim 8, wherein the logic is to ignore, in response to the one or more debug commands, one or more commands issued to the processor by another processor.

11. The processor of claim 8, wherein the processing unit(s) are to execute system software in a non-debug mode to help maintain coherence between the cache memory and data locations external to the processor.

12. The processor of claim 8, wherein the logic comprises a trace array to receive data accessed from one or more data locations external to the processor.

13. The processor of claim 8, wherein the debug port is a Joint Team Access Group (JTAG) port.

14. A system comprising:
a host to issue one or more debug commands;
a memory controller;
system memory coupled to the memory controller; and
a processor comprising one or more processing units to execute software, cache memory to store data for the software, a debug port coupled to receive one or more debug commands from the host, and logic to, in response to the one or more debug commands, stop execution of the software, flush data from the cache memory to the system memory, access the system memory, and resume execution of the software.

15. The system of claim 14, wherein the logic is to issue, in response to the one or more debug commands, one or more commands to stop issuance of commands to the processor by another processor.

16. The system of claim 14, wherein the logic is to ignore, in response to the one or more debug commands, one or more commands issued to the processor by another processor.

17. The system of claim 14, wherein the processing unit(s) are to execute system software in a non-debug mode to help maintain coherence between the cache memory and the system memory.

18. The system of claim 14, wherein the logic comprises a trace array to receive data accessed from the system memory.

19. The system of claim 14, wherein the debug port is a Joint Team Access Group (JTAG) port.

20. The system of claim 14, comprising a graphics processor comprising the memory controller.
